(19) United States
(12) Patent Application Publication
(10) Pub. No.: US 2009/0032549 A1
(43) Pub. Date: Feb. 5, 2009

(54) Pump assembly with sound emitting device

(76) Inventors: Christopher G. Rowen, Rockport, MA (US); Thomas Sweet, Pittsford, NY (US)

Correspondence Address: Paul J. Cook, 115 Pine Street, Manchester, MA, 01944, US

(21) Appl. No.: 11/881,784

(22) Filed: Jul. 30, 2007

(51) Int. Cl. B67D 5/00; G01F 11/00

(52) U.S. Cl. 222/39; 222/321.9

(57) ABSTRACT

A container for a liquid is provided with a pressurizing pump sprayer that includes a sound emitting device. The sound emitting device emits a sound in response to pressure on a plate of the pressurizing pump sprayer.

### FIELD OF THE INVENTION

This invention relates to a pump assembly having a hand activated sound emitting circuit.

### BACKGROUND OF THE INVENTION

Pressurizing pump sprayers commonly utilize an integral cylinder and plunger arrangement to generate pressure and to expel a liquid such as soap from a container. Pressurizing pump sprayers are desirable in that they do not utilize pressurized containers which must be handled carefully and at controlled temperatures to avoid the risk of explosion. Pressurizing pump sprayers have a number of other advantages, including not using propellants which destroy the ozone and being relatively inexpensive.

There are two common varieties of pressurizing pump sprayers those that are pressurized on the upstroke and those that are pressurized on the down stroke. Pump sprayers that are pressurized on the down stroke typically utilize a return spring which biases the plunger upward after the pressurization stroke. Such pump sprayers are commonly utilized with a hand held container to dispense liquid skin care products such as liquid soap or skin moisturizer.

It is common experience that children avoid washing their hands prior to eating or subsequent toilet activity. In addition, containers for liquid soap having a down stroke pump sprayer can be easily manipulated by children.

Accordingly, it would be desirable to provide a container for a liquid such as soap which includes a feature that would encourage children to use it. Such a feature would promote hygiene of children during common activities such as dining or interacting with other children.

### SUMMARY OF THE INVENTION

The present invention provides a pressurizing pump sprayer having a sound emitter system that is activated when the pump sprayer is activated such as when applying pressure by hand. The present invention also provides an apparatus comprising a container for a liquid to be dispensed and the pressurizing pump sprayer which, when activated, emits a sound and dispenses liquid from the container to a point of use of the liquid. The sound emitter is positioned into the portion of the pump sprayer which is contacted by the user to activate the pump sprayer. The sound emitter includes a power supply, a circuit board, a sound chip, a sound emitting device and an activation switch.

### BRIEF DESCRIPTION OF THE DRAWINGS

FIG. 1 is a perspective view of the container and pump sprayer of this invention.

FIG. 2 is a cross-sectional view of the apparatus of FIG. 1 in use.

FIG. 3 is a exploded perspective view of the sound emitting device of this invention.

FIG. 4 a is a bottom perspective view of the switch of this invention.

FIG. 4b is a cross-sectional view of the switch of FIG. 4a when it is not depressed.

FIG. 4c is a cross-sectional view of the switch of 4a when depressed.

FIG. 5 is a cross sectional view of the sound emitting device of FIG. 3 without connecting wires.

FIG. 6 is a bottom view of the plate housing the sound emitting device of this invention.

FIG. 7a is a side view of a plate of a pump dispenser of this invention wherein a switch is positioned within the plate.

FIG. 7b is a cross-sectional view of the plate of FIG. 7a.

FIG. 8a is an exploded view of a sound emitting device of this invention attachable to a plate of a pump dispenser of this invention.

FIG. 8b shows the sound emitting device of FIG. 8a positioned on a plate of a pump dispenser.

### DESCRIPTION OF SPECIFIC EMBODIMENTS

In accordance with this invention, a pressurizing pump dispenser includes a sound emitting device secured to a container for a liquid to be dispensed. The pump dispenser can be detached from the container and then attached to a second container, usually after the liquid in the first container is depleted. The combination of a container for a liquid attached to a pump dispenser of this invention comprises a second embodiment of this invention.

The sound emitting device of this invention comprises a hand activated switch and a sound emitter that is activated by the switch. The sound emitter and switch are positioned in or on a plate which can be depressed by hand to activate the pump dispenser. The sound emitter emits a sound such as a voice message, for example a voice message which encourages the use of the pump dispenser.

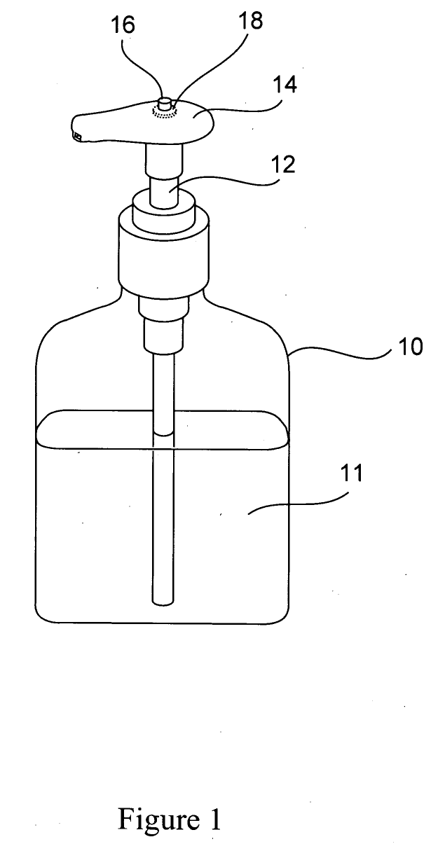

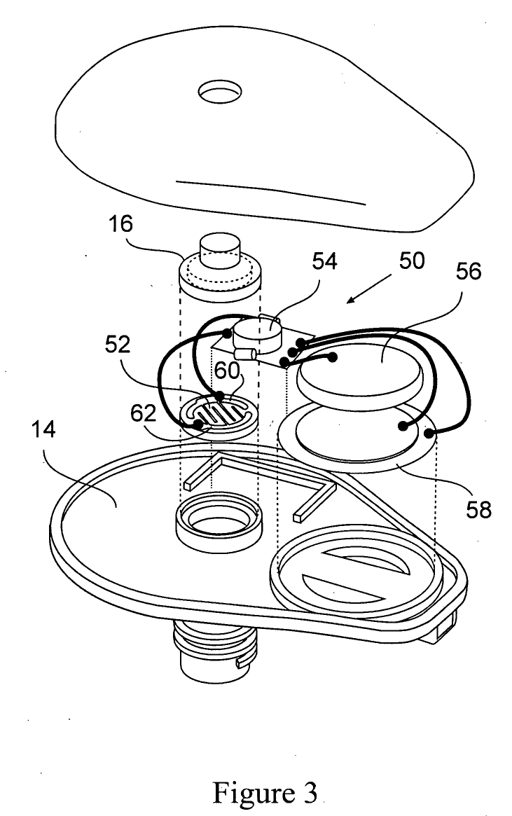

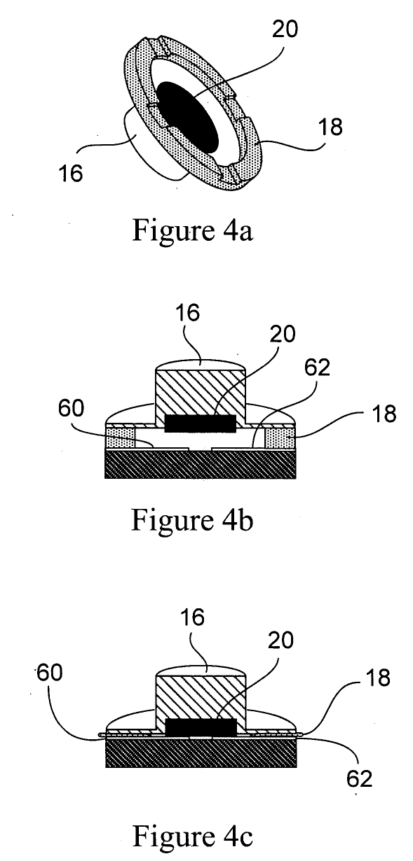

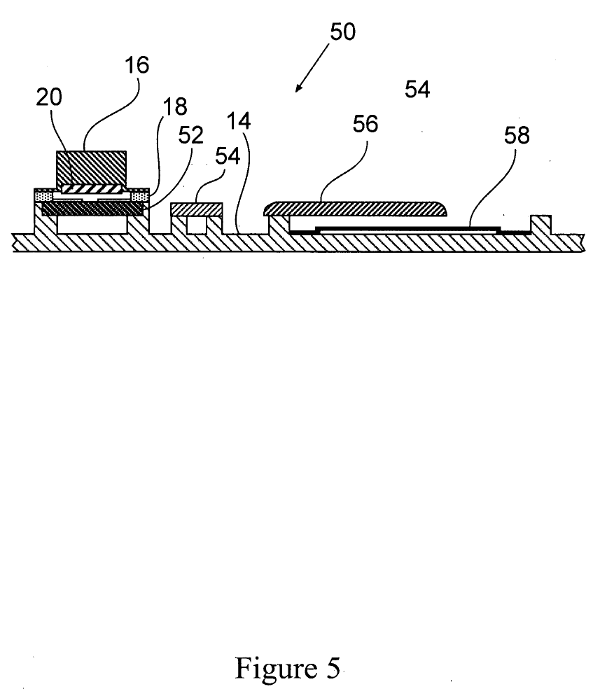

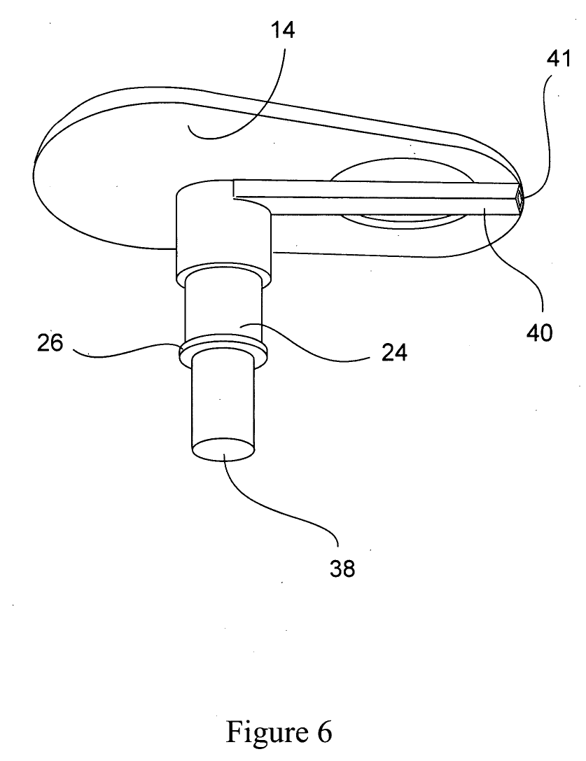

Referring to FIG. 1, the combination of a container 10 for a liquid 11 to be dispensed and the pressurizing pump dispenser 12 is shown. The container 10 in FIG. 1 is shown as a transparent container. The pump dispenser 12 includes a plate 14 to which is secured an activation switch 16 having a flexible housing 18. The activation switch 16 is activated by hand when the user contacts the switch 16 to depress the plate 14. The pressure applied to depress the plate 14 compresses housing 18 (FIG. 4c) to move the switch 16 downwardly to contact poles 60 and 62 of battery 52 (FIG. 3) and activate a sound emitting device 56 and 58 (FIG. 3) positioned within plate 14. The switch 16, comprises a metal contact 20 (FIGS. 4a, 4b, 4c and 5) positioned within flexible housing 18. When the hand of the user is applied to the switch 16, the flexible housing 18 contracts to permit contact of the metal contact 20 with the poles 60 and 62 (FIG. 4c). When the hand of the user is removed from the switch 16, the flexible housing 18 (FIG. 4b) expands so that the metal contact 20 is removed from contact with the poles 60 and 62 of sound emitting device.

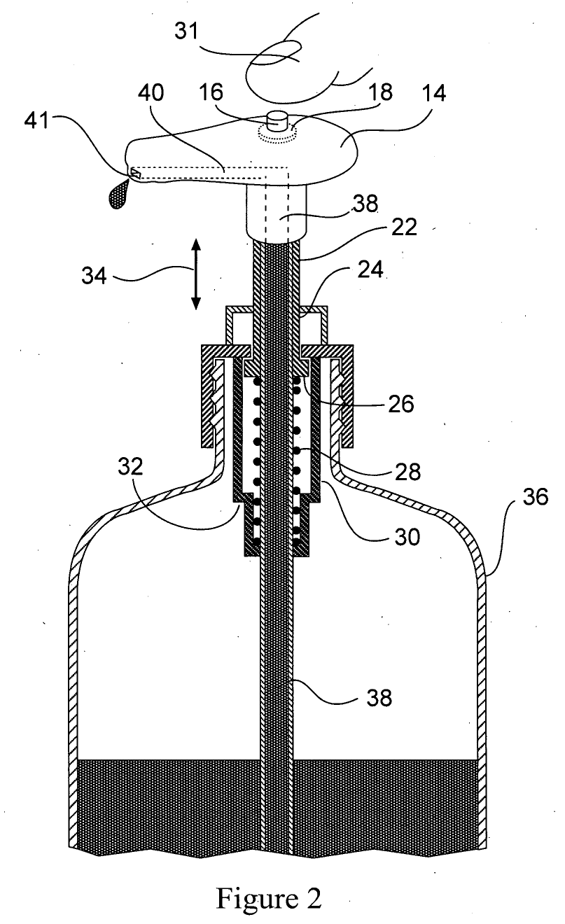

Referring to FIG. 2, the plate 14 is mounted on the upper end 22 of the conduit 24. The conduit 24 is provided with a movable flange 26 secured thereto. The movable flange 26 and spring 28 are positioned within housing 30. Housing 30 is provided with a stop flange 32. The conduit 24 is movable vertically as indicated by arrow 34 between the position shown and to the position wherein the spring 36 is fully compressed by hand pressure provided by finger 31 between movable flange 26 and stop flange 32. When container 36 contains liquid, liquid is pumped through fluid pathways 38 and 40 which are in fluid communication with each other and out outlet 41. When hand pressure is released, the conduit 24 returns to the position shown in FIG. 2. During the time hand pressure is applied to switch 16, compressible housing 18 is compressed to move the switch 16 into contact with a sound emitting device 50 (FIG. 3) positioned within plate 14. The structure of the sound emitting device will be explained below with reference to FIGS. 3 and 5.

Referring to FIGS. 3 and 5, the sound emitting device 50 of the invention which is positioned within plate 14 is shown. The sound emitting device 50 includes a battery 52, a circuit board 54, a sound chip 56 such as a chip that stores sound digitally and a speaker, vibrating filament or the like 58 which are electronically connected to each other. The battery 52 has a positive pole 60 and a negative pole 62 which are not connected initially. Electrical connection of the poles 60 and 62 is effected by switch 16 when it is depressed by a user to contact poles 60 and 62. The circuit 54 board functions to receive and store electrical power from battery 52 and to provide electrical current to sound chip 56 for a desired time period, typically from about 2 to about 10 seconds. The sound chip 56 is programmed to deliver a desired audio message to speaker; vibrating filament or the like 58 which emits the desired audio message to the user of the device. By operating in this manner, a desired audio message is delivered to the user in response to the user's depressing switch 16. Any audio message can be programmed into the sound chip 56 as desired.

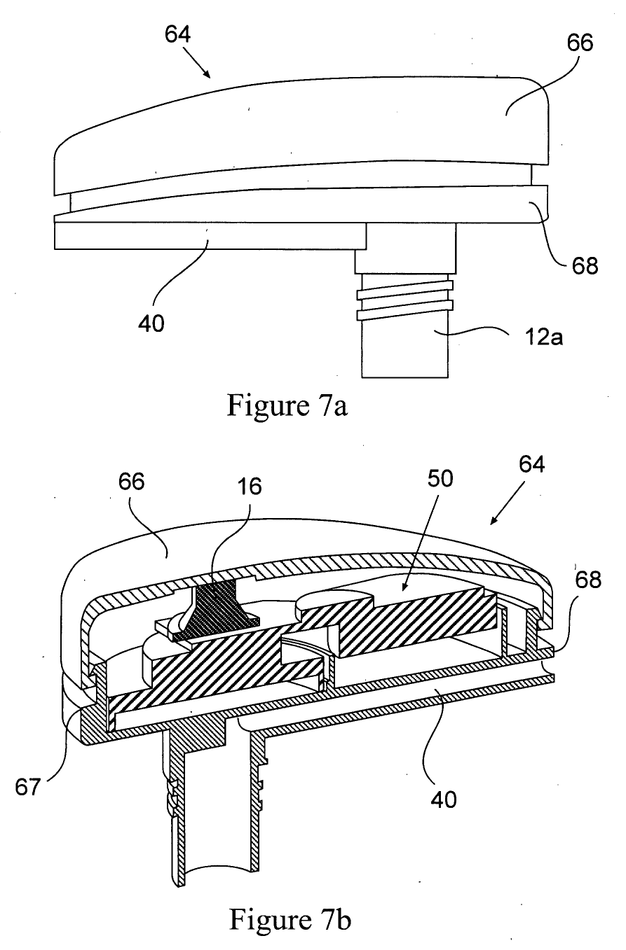

Referring to FIGS. 7a and 7b an embodiment of this invention is shown wherein the switch 16 is positioned within a housing for the sound emitting device 50. The housing 64 is formed of a top section 66 and a bottom section 68 which are snap fit together to house switch 16 and sound emitting device 50. Housing 64 is secured to pump dispenser 12a which functions in the same manner as pump dispenser 12. Switch 16 and sound emitting device 50 operate in the manner as set forth above. When pressure is applied to top section 66, it moves downwardly to contact flange 67 and to compress activation switch 16 (FIG. 4c). When pressure is removed from top section 66, switch 16 returns to the position shown in FIG. 4b.

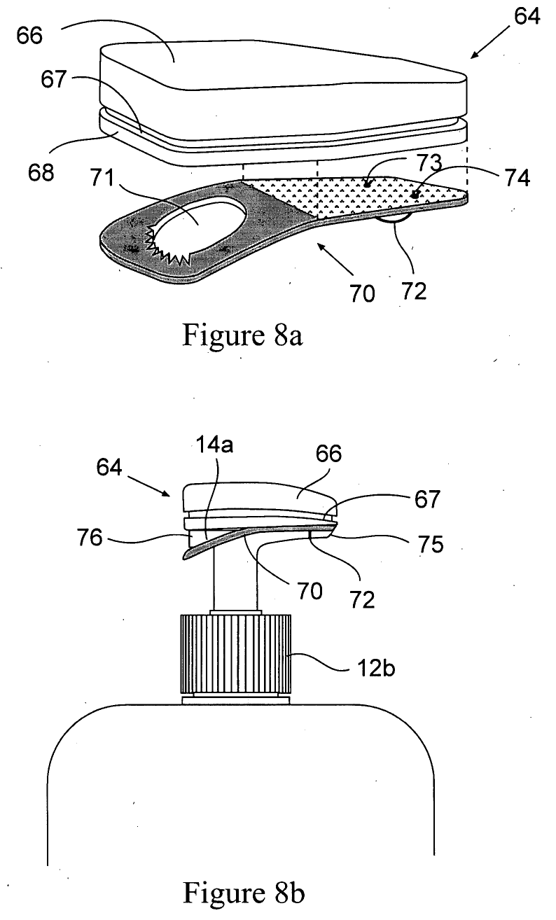

Referring to FIGS. 8a and 8b, the sound emitting device 50 and switch 16 are housed within housing 64 comprising a top section 66 and a bottom section 68 which function in the manner described above with reference to FIGS. 7a and 7b. In this embodiment, the housing 64 is attached to a flexible plate attachment device 70. Plate attachment device 70 is formed of a stretchable material that permits its attachment to plate 14a of pump 12b. Plate attachment device 70 and housing 64 are secured together by any conventional means such as adhesive, nails, Velcro or the like. The plate attachment device includes a hole 71 and line such as a string, thread of the like 72 secured to the device 70 such as by tied knots 73 and 74. String 72 can be stretchable or non-stretchable. In use, the string 72 is positioned over the front end 75 of plate 14a. The device 70 then is stretched to position it over the back 76 of plate 14a. When it is desired to remove housing 64 from plate 14a, the device 70 is stretched to remove the hole 71 and string 72 from the plate 14a. This embodiment permits reuse of the sound emitting device of the invention from container to container.

1. A pressurized pump sprayer which comprises:
a plate containing a sound emitting device and a switch adapted to activate said sound emitting device in response to increased pressure on said switch,
said plate having a first conduit being in fluid communication with a second conduit,
and said second conduit being connected to a means for reciprocating said second conduit in response to pressure on said plate.

2. The pressurizing pump sprayer of claim 1 wherein said means for reciprocating comprises a spring.

3. A container construction for delivering a liquid and for emitting a sound in conjunction with delivering said liquid which comprises:
a container for said liquid,
a plate containing a sound emitting device and a switch adapted to activate said sound emitting device in response to increased pressure on said switch,
said plate having a first conduit being in fluid communication with a second conduit,
said second conduit being connected to a means for reciprocating said second conduit in response to pressure on said plate,
and means for securing said plate to said container while positioning said second conduit within said container.

4. The pressurizing pump sprayer of claim 1 wherein said means for reciprocating comprises a spring.

5. A sound emitting apparatus suitable for being attached to or detached from a plate of a pump sprayer which comprises:
a sound emitting device capable of emitting a sound having a movable switch positioned within a housing,
said housing having a first housing section which is movable under pressure with respect to a second housing section,
said sound emitting device including a switch which moves in response to movement of said first housing section to activate or deactivate said sound emitting device,
and said housing being secured to an attachment means capable of being attached and detached from said plate.

6. The sound emitter apparatus of claim 5 wherein said attachment means includes a stretchable substrate having a hole and a line secured thereto,
said hole and thread adapted to be positioned over opposing sections of a plate of a pump sprayer.

7. A container construction for delivering a liquid and for emitting a sound in conjunction with delivering said liquids which comprises:
a container for said liquid,
a sound emitting device capable of emitting a sound having a movable switch positioned within a housing,
said housing having a first housing section which is movable under pressure with respect to a second housing section,
said sound emitting device including a switch which moves in response to movement of said first housing section to activate or deactivate said sound emitting device,
said housing being secured to an attachment means capable of being attached and detached from said plate,
and said housing and attachment means secured to a plate of said container.
